(19) United States
(12) Patent Application Publication
(10) Pub. No.: US 2021/0283661 A1
(43) Pub. Date: Sep. 16, 2021

(54) ASSESSING A PLASTIC CONTAINER FOR REUSE OR RECYCLING

(71) Applicant: BROOQ PETROCHEMICAL COMPANY, Doha (QA)

(72) Inventor: Abdulrahman AL-THANI, Doha (QA)

(21) Appl. No.: 16/817,327

(22) Filed: Mar. 12, 2020

(51) Int. Cl. B07C 5/34

(52) U.S. Cl. CPC B07C 5/3412; B65D 23/14; B07C 5/3408

(57) ABSTRACT

Systems, methods, apparatuses, and computer program products for assessing a plastic container for reuse or recycling. For example, certain embodiments may provide a system that is capable of scanning a tag associated with the plastic container and determining whether to assess the plastic container for suitability for reuse or for recycling based on information scanned from the tag. With respect to recycling specifically, certain embodiments may be capable of assessing the plastic container's suitability for use as an input material to an additive manufacturing process. After assessing the plastic container, the system may perform one or more actions to reuse or recycle the plastic container.

### FIELD

Some example embodiments may generally relate to plastic containers. For example, certain embodiments may relate to systems and/or methods for assessing a plastic container for reuse or recycling.

### BACKGROUND

A fluid may be transported and/or dispensed from a plastic container. For example, a water dispenser, such as a top-loaded water dispenser, may dispense water from a plastic bottle. In this example, the plastic bottle may be swapped out for a different plastic bottle when empty.

### SUMMARY

According to a first embodiment, a method may include receiving, by a system, information based on a scan of a tag associated with a plastic container. The information may identify at least a day that the container left a facility, or a quantity of times that the container has been used. The method may include determining whether the quantity of times satisfies a first threshold or whether a number of days since the day that the container left the facility satisfies a second threshold. The method may include, based on whether the quantity of times satisfies the first threshold or the number of days satisfies the second threshold, assessing the plastic container for use as an input material for an additive manufacturing process, or assessing the plastic container for reuse. The method may include performing one or more actions related to recycling the plastic container, or reusing the plastic container.

In a variant, the tag may comprise at least one of: a barcode, a quick response (QR) code, or a radio frequency identifier (RFID) tag. In a variant, assessing the plastic container for reuse may further comprise assessing whether an interior surface of the plastic container leaches a threshold amount of a chemical. In a variant, assessing the plastic container for reuse may further comprise assessing a structural integrity of the plastic container for holding a threshold amount of material.

In a variant, assessing the structural integrity of the plastic container may further comprise assessing whether the plastic container can sustain a threshold amount of pressure applied to the interior or to the exterior of the plastic container. In a variant, assessing the structural integrity of the plastic container may further comprise assessing whether the plastic container leaks when filled with a fluid. In a variant, assessing the plastic container for use as the input material may further comprise assessing whether there is material present on an interior surface or an exterior surface of the plastic container.

In a variant, performing the one or more actions for reuse may comprise one or more of: moving the plastic container to an area of the facility associated with reusing the plastic container, sanitizing the plastic container, or filling the plastic container with a material. In a variant, performing the one or more actions related to recycling the plastic container may comprise one or more of: moving the plastic container to an area of the facility associated with recycling the plastic container, cleaning the plastic container, shredding the plastic container, or processing the shredded plastic container into the material. In a variant, the method may further comprise activating an alarm or outputting a message to a device indicating that the number of days satisfies the first threshold or the quantity of times satisfies the second threshold.

According to a second embodiment, a method may include receiving, by a system, information based on a scan of a tag associated with a plastic container. The information may identify at least: a day that the container left a facility, or a quantity of times that the container has been used. The method may include determining whether the quantity of times satisfies a first threshold or whether a number of days since the day that the container left the facility satisfies a second threshold. The method may include, based on the quantity of times failing to satisfy the first threshold or the number of days failing to satisfy the second threshold, assessing the plastic container for reuse. The method may include performing one or more actions related to reusing the plastic container based on assessing the plastic container for reuse.

In a variant, assessing the plastic container for reuse may further comprise assessing whether an interior surface of the plastic container leaches a threshold amount of a chemical. In a variant, assessing the plastic container for reuse may comprise assessing a structural integrity of the plastic container for holding a liquid. In a variant, assessing the structural integrity of the plastic container, may comprise assessing whether the plastic container can sustain a threshold amount of pressure applied to the interior or to the exterior of the plastic container. In a variant, performing the one or more actions for reuse may comprise moving the plastic container to an area of the facility associated with reusing the plastic container, sanitizing the plastic container, or filling the plastic container with a material.

According to a third embodiment, a method may include receiving, by a system, information based on a scan of a tag associated with a plastic container. The information may identify at least a day that the container left a facility, or a quantity of times that the container has been used. The method may include determining whether the quantity of times satisfies a first threshold or whether a number of days since the day that the container left the facility satisfies a second threshold. The method may include, based on whether the quantity of times satisfying the first threshold or the number of days satisfying the second threshold, assessing the plastic container for use as an input material for an additive manufacturing process. The method may include performing one or more actions related to recycling the plastic container.

In a variant, assessing the plastic container for use as the input material may further comprise assessing whether material is present on an interior surface or an exterior surface of the plastic container. In a variant, assessing whether the material is present may further comprise assessing whether the material can be removed via a cleaning process. In a variant, performing the one or more actions related to recycling the plastic container may further comprise moving the plastic container to an area of the facility associated with recycle the plastic container, cleaning the plastic container, shredding the plastic container, or processing the shredded plastic container into the material. In a variant, the method may further include activating an alarm or outputting a message to a device indicating that the number of days or the quantity of times satisfies the threshold.

A fourth embodiment may be directed to an apparatus including at least one processor and at least one memory comprising computer program code. The at least one memory and computer program code may be configured, with the at least one processor, to cause the apparatus at least to perform the method according to the first embodiment, the second embodiment, or the third embodiment, or any of the variants discussed above.

A fifth embodiment may be directed to an apparatus that may include circuitry configured to perform the method according to the first embodiment, the second embodiment, or the third embodiment, or any of the variants discussed above.

A sixth embodiment may be directed to an apparatus that may include means for performing the method according to the first embodiment, the second embodiment, or the third embodiment, or any of the variants discussed above.

A seventh embodiment may be directed to a computer readable medium comprising program instructions stored thereon for performing at least the method according to the first embodiment, the second embodiment, or the third embodiment, or any of the variants discussed above.

An eighth embodiment may be directed to a computer program product encoding instructions for performing at least the method according to the first embodiment, the second embodiment, or the third embodiment, or any of the variants discussed above.

### BRIEF DESCRIPTION OF THE DRAWINGS

For proper understanding of example embodiments, reference should be made to the accompanying drawings, wherein:

FIG. 1a illustrates an example of assessing a plastic container for reuse or recycling, according to some embodiments;

FIG. 1b further illustrates the example of assessing a plastic container for reuse or recycling, according to some embodiments;

FIG. 2 illustrates an example of scanning a tag associated with a plastic container, according to some embodiments;

FIG. 3a illustrates an example process for scanning a tag of a plastic bottle that is inbound to a facility, according to some embodiments;

FIG. 3b illustrates an example process for scanning a tag of a plastic bottle that is outbound from a facility, according to some embodiments;

FIG. 4 illustrates a flow diagram of a method for assessing a plastic bottle for reuse or recycling, according to some embodiments;

FIG. 5 illustrates an example flow diagram of a method for assessing a plastic bottle for reuse, according to some embodiments;

FIG. 6 illustrates an example flow diagram of a method for assessing a plastic bottle for recycling, according to some embodiments; and

FIG. 7 illustrates an example block diagram of an apparatus, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for assessing a plastic container for reuse or recycling is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments. In addition, the phrase “set of” refers to a set that includes one or more of the referenced set members. As such, the phrases “set of,” “one or more of,” and “at least one of,” or equivalent phrases, may be used interchangeably.

Additionally, if desired, the different functions or operations discussed below may be performed in a different order and/or concurrently with each other. Furthermore, if desired, one or more of the described functions or operations may be optional or may be combined. As such, the following description should be considered as merely illustrative of the principles and teachings of certain example embodiments, and not in limitation thereof.

Plastic containers may be used to store fluids for transportation, dispensement, and/or the like. These types of plastic containers may have a limited useful life. For example, the chemical compositions of plastic containers may begin to breakdown overtime, based on a number of times that the bottle has been used (e.g., emptied and refilled), due to exposure to environmental factors, such as sunlight, heat, etc., and/or the like. As a specific example, a plastic bottle may leech chemicals, such as bisphenol-A (BPA), into water in the plastic bottle when exposed to sunlight and/or heat for an extended amount of time. Some chemicals that can leech from these plastic bottles may cause various health-related issues if consumed in certain concentrations. As such, there is a need for assessing a plastic container for reuse, and assessing for leeching of chemicals is one example of a factor that could impact a plastic bottle's suitability for reuse.

Some plastic containers can be recycled after use (or after expiration of their useful life), depending on the type of plastic material used to form the plastic container. Even if a plastic container can be recycled, the plastic container may not be suitable for recycling. For example, the plastic container may be dirty, may have a label attached to it, and/or the like, especially if the recycled material will be used for a particular purpose. As such, there is a need for assessing a plastic container's suitability for recycling.

Some embodiments described herein may provide a system that is capable of assessing a plastic container for reuse or recycling. For example, certain embodiments may provide a system that is capable of scanning a tag associated with the plastic container and determining whether to assess the plastic container for suitability for reuse or for recycling based on information scanned from the tag. With respect to recycling specifically, certain embodiments may be capable of assessing the plastic container's suitability for use as an input material to an additive manufacturing process. After assessing the plastic container, the system may perform one or more actions to reuse or recycle the plastic container.

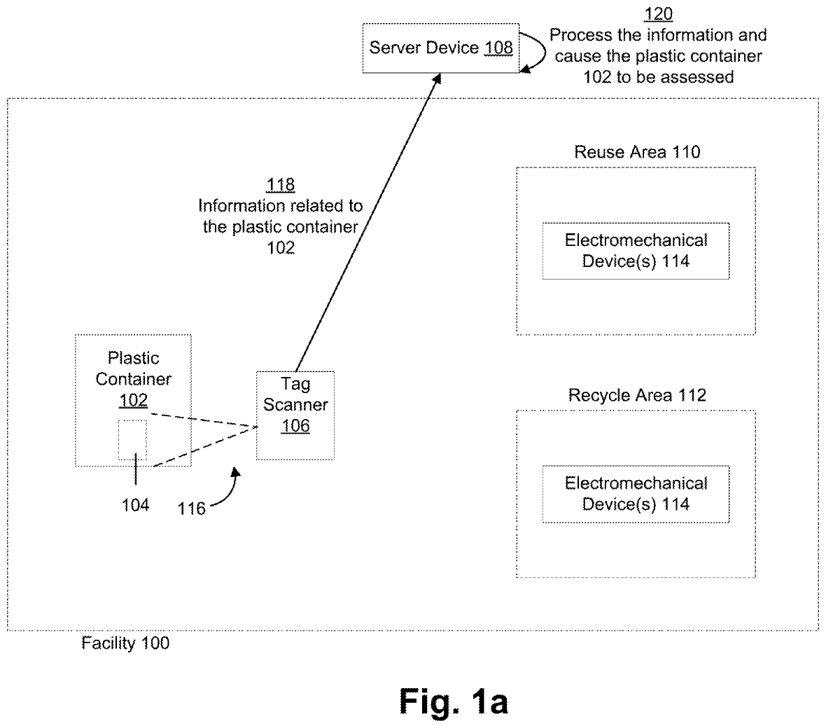

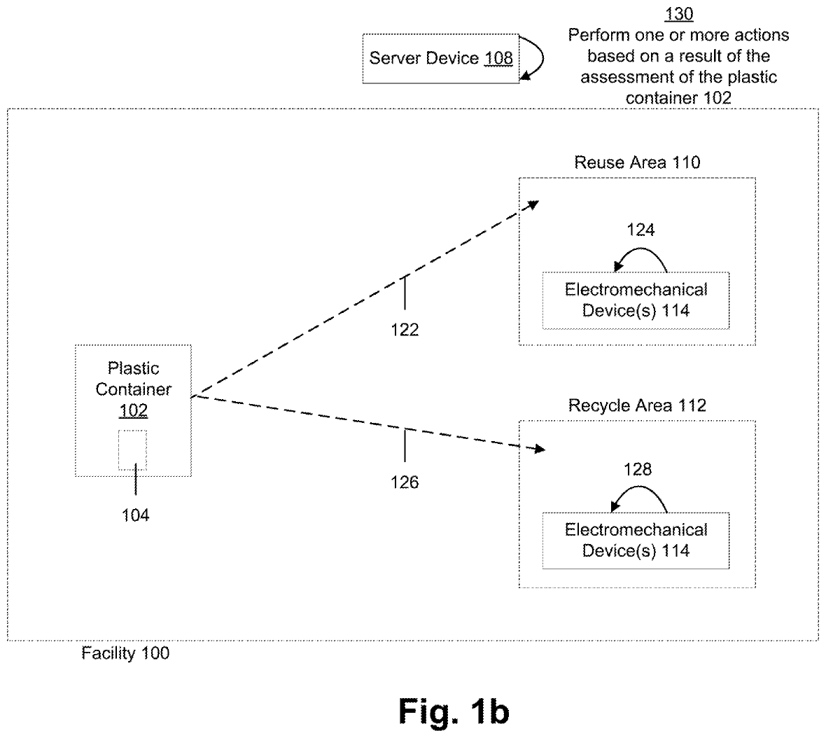

FIGS. 1a and 1b illustrate an example of assessing a plastic container for reuse or recycling, according to some embodiments. FIGS. 1a and 1b illustrate a facility 100 (e.g., a recycling facility, a refilling facility, a distribution center, and/or the like). As illustrated, the facility 100 may have received a plastic container 102 (e.g., a plastic bottle, a plastic bin, and/or the like) that includes a tag 104 (e.g., a radio frequency identifier (RFID) tag, a Quick Response (QR) code, a barcode, and/or another type of machine-readable tag). The facility 100 may include a tag scanner 106 (e.g., a radio frequency (RF) scanner, an optical scanner, and/or another type of scanner capable of scanning the tag 104).

In addition, certain devices of the facility 100 may be in communication with a server device 108 (e.g., local/on-site at the facility 100 or remote from the facility 100). The facility 100 may further include a reuse area 110 and a recycle area 112, described elsewhere herein. The reuse area 110 and the recycle area 112 may each include one or more electromechanical devices 114 that may be used to assess the plastic container 102's suitability for reuse or recycling, as described elsewhere herein.

As illustrated at 116, the tag scanner 106 may scan the tag 104 during intake of the plastic container 102 to the facility 100. For example, the tag scanner 106 may be mounted on a vehicle to scan the tag 104 upon off-loading of the plastic container 102 from the vehicle, may be mounted to an entrance of the facility 100 to scan the plastic container 102 upon the plastic container 102 being brought into the facility 100, may be mounted to a conveyor belt to scan the tag 104 as the plastic container 102 is moved along the conveyor belt, may be mounted to a forklift (or a similar machine) to scan the tag 104 as the plastic container 102 is loaded onto, or off-loaded from, the forklift, may be included in a handheld device that a facility worker may use to scan the tag 102, may be mounted to a robot that moves about the facility 100 to process plastic containers 102 during intake, and/or the like.

As illustrated at 118, the tag scanner 106 may transmit, and the server device 108 may receive, information related to the plastic container 102. For example, the information transmitted to the server device 108 may be information gathered from the tag 104 during scanning of the tag 104 by the tag scanner 106. The information related to the plastic container 102 may identify a date the plastic container 102 was produced or first left the facility 100, a quantity of times that the plastic container 102 has been used (e.g., refilled, reused, etc.), a unique identifier for the plastic container 102, environmental conditions experienced by the plastic container 102 (e.g., over time or since the last time the facility 100 processed the plastic container 102), former contents of the plastic container 102, and/or the like. The tag scanner 106 may provide the information related to the plastic container 106 upon gathering the information from the tag 104, upon input from a user of the tag scanner 106, based on a request for the information from the server device 108, and/or the like.

As illustrated at 120, the server device 108 may process the information and may cause the plastic container 102 to be assessed. When processing the information, the server device 108 may determine whether a quantity of times that the plastic container 102 has been reused satisfies a threshold (e.g., whether the quantity of times is greater than or equal to a threshold). Additionally, or alternatively, when processing the information the server device 108 may determine whether a quantity of days since the plastic container 102 first left the facility 100 or was produced satisfies a threshold (e.g., whether the quantity of days is greater than or equal to the threshold). The server device 108 may perform other processing operations on the information, such as determining whether the plastic container 102 held certain materials, determining whether the environmental conditions satisfied a threshold, obtaining a record from a database related to the plastic container 102, and/or the like.

Based on the processing, the server device 108 may cause the plastic container 102 to be assessed. For example, the server device 108 may send a set of instructions to a device to cause the plastic container 102 to be moved to the reuse area 110 so that the plastic container 102 can be assessed for reuse or to the recycle area 112 so that the plastic container 102 can be assessed for recycling. The server device 108 may provide the instructions to a robot, a conveyor belt, a user device associated with a facility worker, and/or the like to cause actuation of one or more mechanical components to move the plastic container 102 to the reuse area 110 or the recycle area 112, to cause a worker in facility 100 to move the plastic container 102 to the reuse area 110 or the recycle area 112, and/or the like.

The server device 108 may provide, in association with the instructions, information that identifies one or more tests to be performed to assess the plastic container 102. The one or more tests may include a test of whether the plastic container has a leak, a test of whether the plastic container can withstand a threshold amount of mechanical force applied to the plastic container 102, a test of whether a threshold amount of a chemical compound is present on an interior surface of the plastic container 102, and/or the like in the case of an assessment for reuse. Additionally, or alternatively, the one or more tests may include a test of whether the plastic container 102 is dirty, whether the plastic container 102 has a label on a surface of the plastic container 102, and/or the like in the case of assessment for recycling. The server device 108 may provide the information identifying the one or more tests to a user device of a worker, to the one or more electromechanical devices 114, and/or the like.

Turning to FIG. 1b, and as illustrated at 122, the plastic container 102 may be moved to the reuse area 110 for assessment of the plastic container 102 for reuse. For example, based on the quantity of days and/or the quantity of times failing to satisfy corresponding thresholds, the server device 108 may cause the plastic container 102 to be moved to the reuse area 110 for assessment of the plastic container's suitability for reuse.

As illustrated at 124, the instructions that the server device 108 provided may cause one or more electromechanical devices 114 to assess the plastic container 102. For example, the electromechanical devices 114 may include electromechanical pincers or one or more robotic arms to assess a structural integrity or strength of the plastic container 102. As another example, the one or more electromechanical devices 114 may include a swab and reader system to swab an internal surface of the plastic container 112 and analyze the swap for the presence of a chemical compound, such as BPA, or a microorganism. As another example, the one or more electromechanical devices 114 may include a system that can form a seal with an opening of the plastic container 102 and that can force a pressurized gas or fluid into the plastic container 102 to test whether the plastic container 102 can hold a threshold amount of pressure or whether there is a leak in the plastic container 102 (e.g., if the pressure applied into the plastic container 102 fails to satisfy a threshold, this may indicate a leak in the plastic container 102).

As illustrated at 126, the plastic container 102 may be moved to the recycle area 110 for assessment of the plastic container 102 for recycling (e.g., for recycling into an input material for an additive manufacturing process). For example, based on the quantity of days and/or the quantity of times satisfying corresponding thresholds, the server device 108 may cause the plastic container 102 to be moved to the recycle area 110 for assessment of the plastic container's suitability for recycling.

As illustrated at 128, the instructions that the server device 108 provided may cause one or more electromechanical devices 114 to assess the plastic container 102. For example, the one or more electromechanical devices 114 may include an optical sensor that can identify dirt or a label on the plastic container 102 (e.g., after washing the plastic container). As another example, the one or more electromechanical devices 114 may include a swab and reader system or a spectroscopy system that can analyze a degradation of the plastic container 102. In the context of assessing the plastic container 102 as an input material for an additive manufacturing process, the presence of dirt, a label, etc. may prevent the plastic container 102 from being recycled into the input material. In other contexts, these may not prevent the plastic container 102 from being recycled, and the system described may assess whether the plastic container 102 can be recycled for those other purposes.

In some embodiments, with respect to assessment of material on the plastic container 120 (e.g., a chemical, dirt, etc.), the server device 108 may determine whether the material can be removed via washing or neutralized such that the plastic container 120 can be reused or recycled. For example, depending on the compound, concentration of the compound, and/or the like, the server device 108 may determine whether washing will remove the material, whether another compound can be applied to neutralize the compound, and/or the like. The server device 102 may send a set of instructions to have the plastic container 102 washed or the other compound applied. If the material cannot be removed via washing or neutralization, the server device 102 may send a set of instructions to dispose of the plastic container 102, as described elsewhere herein.

As illustrated at 130, the server device 108 may perform one or more actions based on a result of the assessment of the plastic container 102. For example, the one or more electromechanical devices 114 may provide, to the server device 108, information that identifies a result of the assessment of the tests. If the plastic container 102 fails one or more of the tests related to assessing the plastic container 102 for reuse, the server device 108 may cause the plastic container 102 to be moved to the recycle area 112 to be assessed for recycling in the manner described above. If the plastic container 102 fails one or more of the tests related to recycling, the server device 108 may cause the plastic container 102 to be moved to a disposal area of the facility 100 (not shown) for disposal. For example, the plastic container 102 may be melted, compacted, shredded, and/or the like, may be loaded into a container or on a vehicle so that the plastic container 102 can be taken to a landfill, and/or the like.

If the plastic container 102 passes the one or more tests related to assessing suitability for reuse, the server device 102 may cause one or more electromechanical devices 114 to refill the plastic container 102. For example, the server device 102 may send a set of instructions to cause the plastic container 102 to be moved to a refilling station (e.g., that includes a dispenser, a loader, and/or the like) and to cause the plastic container 102 to be filled with a material. The server device 108 may send a set of instructions to the one or more electromechanical devices 114 to cause an interior or an exterior of the plastic container 102 to be washed and/or sanitized prior to filling, to cause a new tag 102 to attached to the plastic container 102 or the tag 102 to be updated, to cause a cap or seal to be placed on an opening of the plastic container 102, and/or the like.

The server device 108 may send a set of instructions to a user device, an autonomous robot, a forklift, a conveyor belt, and/or the like to cause the plastic container 102 to be loaded onto a pallet or other structure, to cause the pallet or other structure to be loaded onto a vehicle, to cause the vehicle to deliver the plastic container 102 to a location (e.g., by providing a set of directions to the vehicle and/or to a navigation system of the vehicle), and/or the like.

If the plastic container 102 passes one or more tests related to assessing suitability for recycling, the server device 108 may provide a set of instructions to the one or more electromechanical devices 114 to recycle the plastic container 102. For example, the one or more instructions may cause the plastic container 102 to be washed (e.g., if dirt or another material was detected on the plastic container 102) by one or more electromechanical devices 114 capable of washing, to be shredded by one or more electromechanical devices 114 capable of shredding, to be melted by one or more electromechanical devices 114 capable of melting, to be formed into a shape (e.g., drawn into a filament, shaped into a block of material, etc.) by one or more electromechanical devices 114 capable of shaping, to be packaged (e.g., after shaping), such as onto a spool or in a group of plastic bricks, and/or the like. In addition, the server device 108 may provide a set of instructions to cause the recycled plastic container 102 to be loaded and/or delivered to a destination in a manner similar to that described above with respect to a refilled plastic container 102. During this process or the reuse process, the server device 108 may provide instructions to a robot, a forklift, a conveyor belt, and/or the like to move the plastic container 102 (or a processed or semi-processed version thereof) to the various electromechanical devices 114 described.

In some embodiments, certain alarms may be activated and/or notifications may be sent depending on whether the plastic container 102 passes or fails a test. For example, if the plastic container 102 fails a test (or if the amount of time or quantity of times satisfy corresponding thresholds), an alarm (e.g., a light, a speaker, and/or the like) may be activated by the server device 108 or the electromechanical device(s) 114 performing the test. Additionally, or alternatively, the electromechanical device 114 or the server device 108 may send a message to a user device of a worker indicating the passage or failure of a test, may populate a record in a database associated with the plastic container 102 with information indicating the passage or failure of the test, may cause the scanner 104 to update the tag 102 with information indicating the passage or failure, and/or the like.

In this way, certain embodiments may provide a system capable of assessing a plastic container 102's suitability for reuse or for recycling, such as recycling into an input material for an additive manufacturing process. This can reduce waste generated from disposal of plastic containers 102 and may provide a way to systematically and accurately make this type of assessment. In addition, certain embodiments may assess a plastic container 102's suitability for reuse using various tests. This may provide a way to systematically and accurately make this type of assessment, which may reduce the risk of lost product, illness, and/or the like that may result from reuse of a plastic container 102 that is not suitable for reuse.

As described above, FIGS. 1a and 1b are provided as an example. Other examples are possible, according to some embodiments.

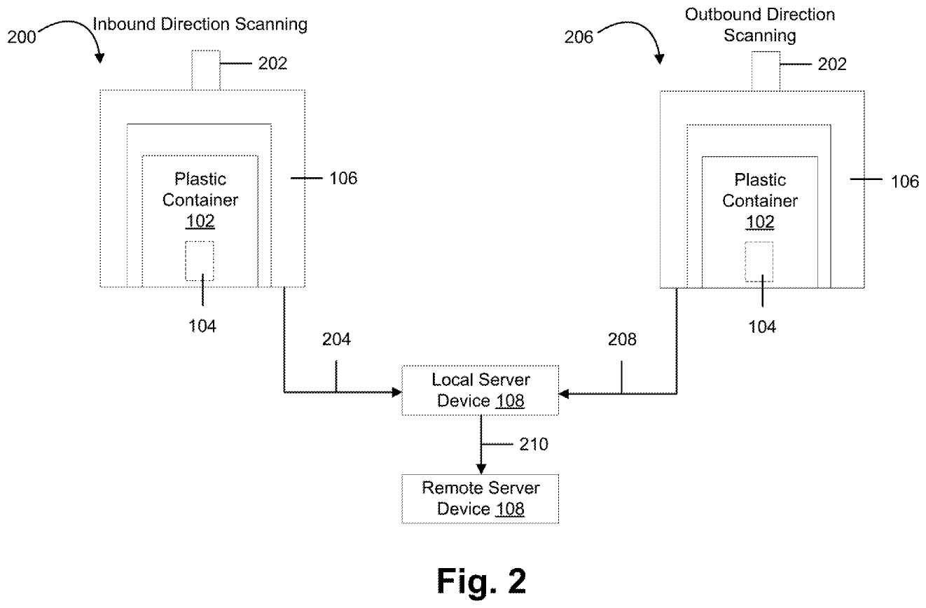

FIG. 2 illustrates an example of scanning a tag associated with a plastic container, according to some embodiments. FIG. 2 illustrates an example 200 of inbound direction scanning of the plastic container 102 (e.g., as the plastic container 102 is inbound to the facility 100, such as at 116 above). The plastic container may be moved through a device that includes tag scanner 106, which may scan the tag 104 (e.g., in a manner similar to that described with respect to 116 above). Based on information gathered from the tag 104, an alarm 102 may be activated (e.g., to indicate whether the quantity of days or the quantity of times satisfies a threshold). As illustrated at 204, the tag scanner 106 may transmit the information gathered from the tag 104 to a local server device 108 (e.g., in a manner similar to that described with respect to reference number 118 above).

FIG. 2 additionally illustrates an example 206 of outbound direction scanning of the plastic container 102 (e.g., as the plastic container 102 is outbound from the facility 100). The tag scanner 106 may scan the tag 104 in a manner similar to that described elsewhere herein or may update the tag 104 (e.g., by increasing the quantity of times information or a quantity of days in use information for the plastic container 102). The alarm 202 may be activated depending on whether the update was successful (e.g., as determined by a scan of the tag 104). As illustrated at 208, the tag scanner 106 may provide information to the local server device 108 indicating updated information provided to the tag 104, whether the update was successful, and/or the like.

The local server device 108 may process the received information at 204 or 208 in a manner similar to that described elsewhere herein. Additionally, or alternatively, the local server device 108 may update a record in a database with the information received at 204 or at 208. For example, for an outbound plastic container 102, the local server device 108 may flag a particular plastic container 102 to be recycled upon the next intake at the facility 100, which may conserve computing and/or processing resources associated with determining whether to reuse or recycle the plastic container 102. The local server device 108 may perform analytics on the information received at 204 or 028, such as determining an average actual life of a plastic container 108, a percentage of plastic containers 102 that are reused, recycled, or disposed of, an amount of time between intake and output of a plastic container 102, and/or the like for the facility 100 and may store information identifying results of the analytics.

As illustrated at 210, the local server device 108 may provide this information, or aggregated information for multiple plastic containers 102, to a remote server device 108. Remote server device 108 may aggregate information across multiple facilities 100 and may perform analytics on this information similar to that described above (e.g., to identify underperforming or over performing facilities 100). The remote server device 108 may store the received information, results of analytics, and/or the like.

As indicated above, FIG. 2 is provided as an example. Other examples are possible, according to some embodiments.

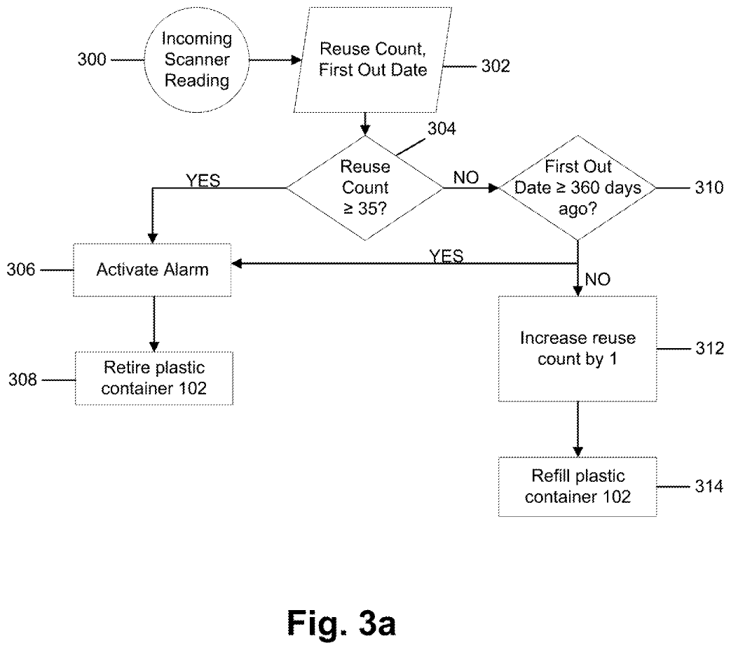

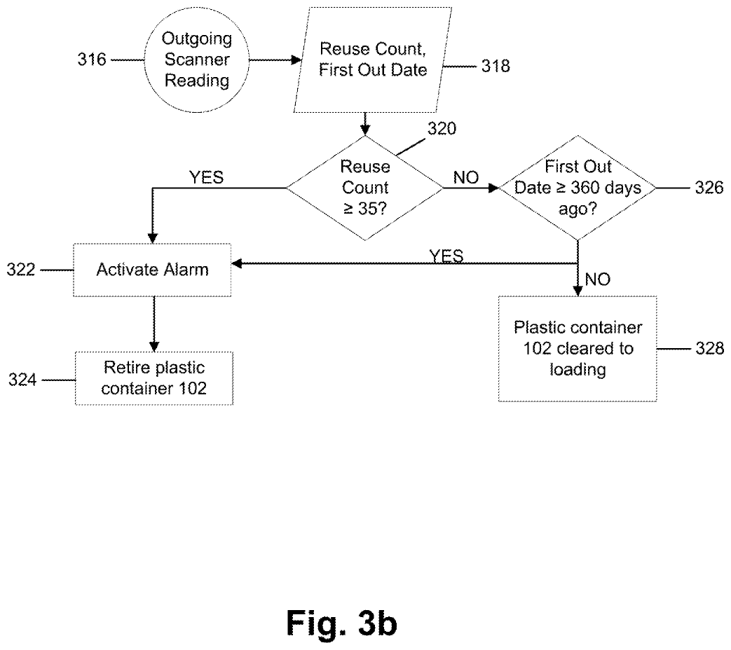

FIG. 3a illustrates an example process for scanning a tag of a plastic container that is inbound to a facility, according to some embodiments. For example, FIG. 3a illustrates a process that may occur with respect to example 200 above. The process may be performed by one or of the devices described herein (e.g., a tag scanner 104, a server device 108, an electromechanical device 114, and/or the like).

As illustrated at 300, an incoming scanner reading may be received from tag scanner 104. At 302, certain information identifying the reuse count (the quantity of timer a plastic container 102 has been used) and the first out date (the day the plastic container 102 was produced or first left the facility 100) may be identified from the incoming scanner reading. At 304, it may be determined whether the reuse count is greater than or equal to 35 (or some other threshold). If the reuse count is greater than or equal to 35 (or the other threshold) (304-YES), then, at 306, an alarm may be activated. At 308, the plastic container 102 may be retired (e.g., recycled or disposed).

If the reuse count is less than 35 (or some other threshold) (304-NO), then, at 310, it may be determined whether the first out date is greater than or equal to 360 days ago (or some other threshold). If the first date out is greater than or equal to 360 days ago (or the other threshold for days) (310-YES), then operations 306 and 308 may be performed. If the first date out is less than 360 days ago (or the other threshold for days) (310-NO), then, at 312, the reuse count may be increased by 1 (or another amount) (e.g., by updating the tag 104). At 314, the plastic container 102 may be refilled with a material or otherwise reused.

As described above, FIG. 3a is provided as an example. Other examples are possible, according to some embodiments.

FIG. 3b illustrates an example process for scanning a tag of a plastic container that is outbound from a facility, according to some embodiments. The operations at 316, 318, 320, 322, 324, and 326 may be similar to operations 300, 302, 304, 306, 308, and 310, respectively. If the first out date is less than 360 days ago (or another threshold) (326-NO), then the plastic container 102 may be cleared to loading (e.g., loaded on a palate or a vehicle).

As described above, FIG. 3b is provided as an example. Other examples are possible, according to some embodiments.

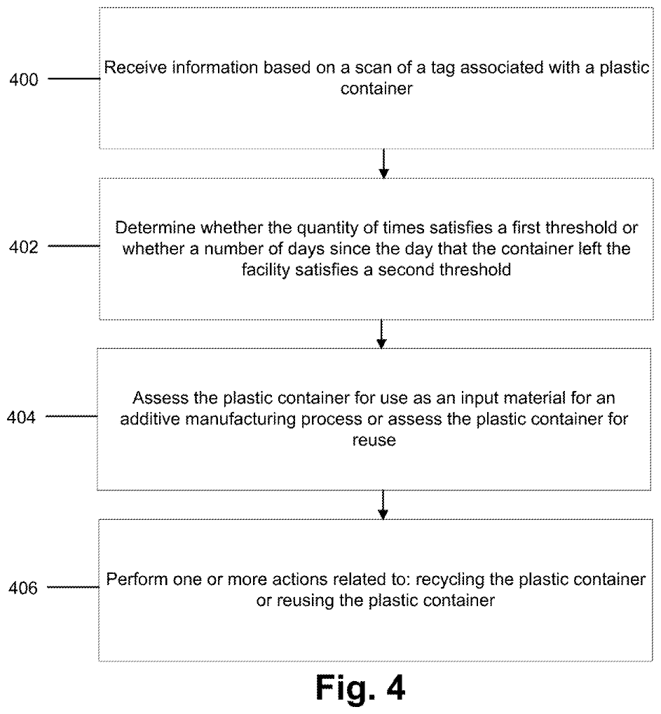

FIG. 4 illustrates an example flow diagram of a method for assessing a plastic bottle for reuse or recycling, according to some embodiments. For example, FIG. 4 shows example operations of a system (e.g., comprising one or more apparatuses 10). Some of the operations illustrated in FIG. 4 may be similar to some operations shown in, and described with respect to, FIGS. 1-3b.

In an embodiment, the method may include, at 400, receiving information based on a scan of a tag associated with a plastic container. The information may identify at least: a day that the container left a facility, or a quantity of times that the container has been used. In an embodiment, the method may include, at 402, determining whether the quantity of times satisfies a first threshold or whether a number of days since the day that the container left the facility satisfies a second threshold. In an embodiment, based on whether the quantity of times satisfies the first threshold or the number of days satisfies the second threshold, the method may include, at 404, assessing the plastic container for use as an input material for an additive manufacturing process, or assessing the plastic container for reuse. In an embodiment, the method may include, at 406, performing one or more actions related to: recycling the plastic container, or reusing the plastic container.

In some embodiments, the tag may comprise at least one of: a barcode, a quick response (QR) code, or a radio frequency identifier (RFID) tag. In some embodiments, assessing the plastic container for reuse may further comprise assessing whether an interior surface of the plastic container leaches a threshold amount of a chemical. In some embodiments, assessing the plastic container for reuse may further comprise assessing a structural integrity of the plastic container for holding a threshold amount of material. In some embodiments, assessing the structural integrity of the plastic container may further comprise assessing whether the plastic container can sustain a threshold amount of pressure applied to the interior or to the exterior of the plastic container. In some embodiments, assessing the structural integrity of the plastic container may further comprise assessing whether the plastic container leaks when filled with a fluid.

In some embodiments, assessing the plastic container for use as the input material may comprise assessing whether there is material present on an interior surface or an exterior surface of the plastic container. In some embodiments, performing the one or more actions for reuse may comprise one or more of moving the plastic container to an area of the facility associated with reusing the plastic container, sanitizing the plastic container, or filling the plastic container with a material. In some embodiments, performing the one or more actions related to recycling the plastic container may comprise one or more of moving the plastic container to an area of the facility associated with recycling the plastic container, cleaning the plastic container, shredding the plastic container, or processing the shredded plastic container into the material. In some embodiments, the method may further comprise activating an alarm or outputting a message to a device indicating that the number of days satisfies the first threshold or the quantity of times satisfies the second threshold.

As described above, FIG. 4 is provided as an example. Other examples are possible according to some embodiments.

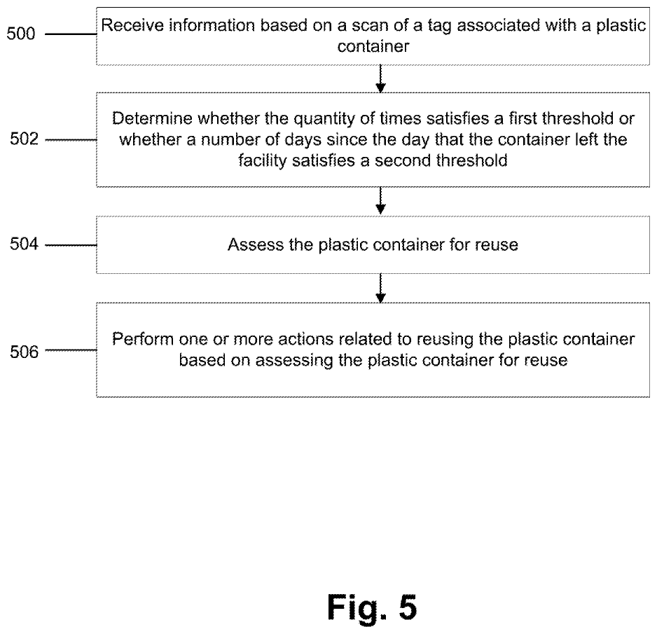

FIG. 5 illustrates an example flow diagram of a method for assessing a plastic bottle for reuse, according to some embodiments. For example, FIG. 5 shows example operations of a system (e.g., comprising one or more apparatuses 10). Some of the operations illustrated in FIG. 5 may be similar to some operations shown in, and described with respect to, FIGS. 1-3b.

In an embodiment, the method may include, at 500, receiving information based on a scan of a tag associated with a plastic container. The information may identify at least: a day that the container left a facility, or a quantity of times that the container has been used. In an embodiment, the method may include, at 502, determining whether the quantity of times satisfies a first threshold or whether a number of days since the day that the container left the facility satisfies a second threshold. Based on the quantity of times failing to satisfy the first threshold or the number of days failing to satisfy the second threshold, the method may include, at 504, assessing the plastic container for reuse. In an embodiment, the method may include, at 506, performing one or more actions related to reusing the plastic container based on assessing the plastic container for reuse.

In some embodiments, assessing the plastic container for reuse may further comprise assessing whether an interior surface of the plastic container leaches a threshold amount of a chemical. In some embodiments, assessing the plastic container for reuse may further comprise assessing a structural integrity of the plastic container for holding a liquid. In some embodiments, assessing the structural integrity of the plastic container may further comprise assessing whether the plastic container can sustain a threshold amount of pressure applied to the interior or to the exterior of the plastic container. In some embodiments, performing the one or more actions for reuse may further comprise moving the plastic container to an area of the facility associated with reusing the plastic container, sanitizing the plastic container, or filling the plastic container with a material.

As described above, FIG. 5 is provided as an example. Other examples are possible according to some embodiments.

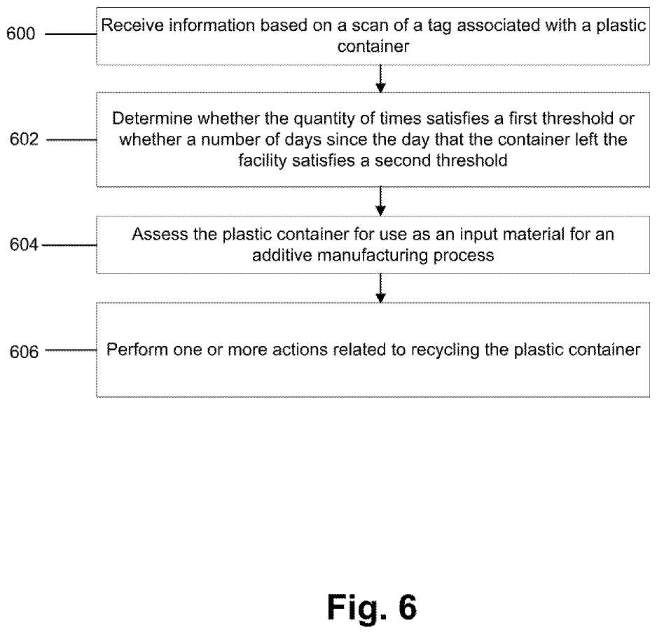

FIG. 6 illustrates an example flow diagram of a method for assessing a plastic container for recycling, according to some embodiments. For example, FIG. 6 shows example operations of a system (e.g., comprising one or more apparatuses 10). Some of the operations illustrated in FIG. 6 may be similar to some operations shown in, and described with respect to, FIGS. 1-3b.

In an embodiment, the method may include, at 600, receiving information based on a scan of a tag associated with a plastic container. The information may identify at least: a day that the container left a facility, or a quantity of times that the container has been used. In an embodiment, the method may include, at 602, determining whether the quantity of times satisfies a first threshold or whether a number of days since the day that the container left the facility satisfies a second threshold. Based on whether the quantity of times satisfies the first threshold or the number of days satisfies the second threshold, the method may include, at 604, assessing the plastic container for use as an input material for an additive manufacturing process. In an embodiment, the method may include, at 606, performing one or more actions related to recycling the plastic container.

In some embodiments, assessing the plastic container for use as the input material may further comprise assessing whether material is present on an interior surface or an exterior surface of the plastic container. In some embodiments, assessing whether the material is present may further comprise assessing whether the material can be removed via a cleaning process. In some embodiments, performing the one or more actions related to recycling the plastic container may further comprise moving the plastic container to an area of the facility associated with recycle the plastic container, cleaning the plastic container, shredding the plastic container, or processing the shredded plastic container into the material. In some embodiments, the method may further comprise activating an alarm or outputting a message to a device indicating that the number of days or the quantity of times satisfies the threshold.

As described above, FIG. 6 is provided as an example. Other examples are possible according to some embodiments.

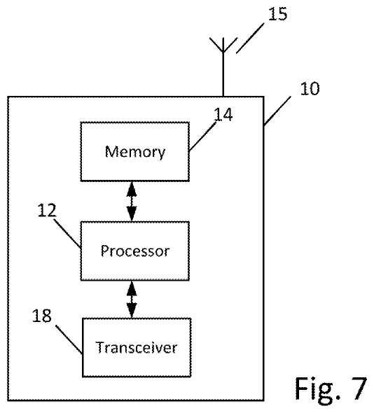

FIG. 7 illustrates an example of an apparatus 10 according to an embodiment. In an embodiment, apparatus 10 may be a computing device, such as a client device or a server in a communications network or serving such a network. For example, apparatus 10 may be a desktop computer, a laptop computer, or a workstation in the case of a client device or may be a server in a datacenter or in a cloud network in the case of a server device. In addition, an electromechanical device may include one or more apparatuses 10.

As illustrated in the example of FIG. 7, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 7, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster). Processor 12 may perform functions associated with the operation of apparatus 10.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. Transceiver 18 may be capable of transmitting and receiving signals or data directly. Additionally or alternatively, in some embodiments, apparatus 10 may include an input and/or output device (I/O device).

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry or control circuitry. In addition, in some embodiments, transceiver 18 may be included in or may form a part of transceiver circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

According to certain embodiments, apparatus 10 may be controlled by memory 14 and processor 12 to perform the functions associated with any of the embodiments described herein, such as some operations of flow or signaling diagrams illustrated in FIGS. 1-6.

For instance, in one embodiment, apparatus 10 may be controlled by memory 14 and processor 12 to receive information based on a scan of a tag associated with a plastic container. The information may identify at least: a day that the container left a facility, or a quantity of times that the container has been used. For instance, in one embodiment, apparatus 10 may be controlled by memory 14 and processor 12 to determine whether the quantity of times satisfies a first threshold or whether a number of days since the day that the container left the facility satisfies a second threshold. For instance, in one embodiment, apparatus 10 may be controlled by memory 14 and processor 12 to, based on whether the quantity of times satisfies the first threshold or the number of days satisfies the second threshold, assess the plastic container for use as an input material for an additive manufacturing process, or assessing the plastic container for reuse. For instance, in one embodiment, apparatus 10 may be controlled by memory 14 and processor 12 to perform one or more actions related to: recycling the plastic container, or reusing the plastic container.

For instance, in one embodiment, apparatus 10 may be controlled by memory 14 and processor 12 to receive information based on a scan of a tag associated with a plastic container. The information may identify at least: a day that the container left a facility, or a quantity of times that the container has been used. For instance, in one embodiment, apparatus 10 may be controlled by memory 14 and processor 12 to determine whether the quantity of times satisfies a first threshold or whether a number of days since the day that the container left the facility satisfies a second threshold. For instance, in one embodiment, apparatus 10 may be controlled by memory 14 and processor 12 to, based on the quantity of times failing to satisfy the first threshold or the number of days failing to satisfy the second threshold, the assess the plastic container for reuse. For instance, in one embodiment, apparatus 10 may be controlled by memory 14 and processor 12 to perform one or more actions related to reusing the plastic container based on assessing the plastic container for reuse.

For instance, in one embodiment, apparatus 10 may be controlled by memory 14 and processor 12 to receive information based on a scan of a tag associated with a plastic container. The information may identify at least: a day that the container left a facility, or a quantity of times that the container has been used. For instance, in one embodiment, apparatus 10 may be controlled by memory 14 and processor 12 to determine whether the quantity of times satisfies a first threshold or whether a number of days since the day that the container left the facility satisfies a second threshold. For instance, in one embodiment, apparatus 10 may be controlled by memory 14 and processor 12 to, based on whether the quantity of times satisfies the first threshold or the number of days satisfies the second threshold, assess the plastic container for use as an input material for an additive manufacturing process. For instance, in one embodiment, apparatus 10 may be controlled by memory 14 and processor 12 to perform one or more actions related to recycling the plastic container.

Therefore, certain example embodiments provide several technological improvements, enhancements, and/or advantages over existing technological processes. For example, one benefit of some example embodiments is reduction of waste with respect to plastic containers, accurate assessment of whether to recycle or reuse a plastic container, and/or the like. Accordingly, the use of some example embodiments results in improved functioning of a recycling or reuse assessment process and, therefore constitute an improvement at least to the technological field of plastic container recycling and reuse, among others.

In some example embodiments, the functionality of any of the methods, processes, signaling diagrams, algorithms or flow charts described herein may be implemented by software and/or computer program code or portions of code stored in memory or other computer readable or tangible media, and executed by a processor.

In some example embodiments, an apparatus may be included or be associated with at least one software application, module, unit or entity configured as arithmetic operation(s), or as a program or portions of it (including an added or updated software routine), executed by at least one operation processor. Programs, also called program products or computer programs, including software routines, applets and macros, may be stored in any apparatus-readable data storage medium and may include program instructions to perform particular tasks.

A computer program product may include one or more computer-executable components which, when the program is run, are configured to carry out some example embodiments. The one or more computer-executable components may be at least one software code or portions of code. Modifications and configurations required for implementing functionality of an example embodiment may be performed as routine(s), which may be implemented as added or updated software routine(s). In one example, software routine(s) may be downloaded into the apparatus.

As an example, software or a computer program code or portions of code may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, such as a non-tangible means that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein apply equally to both singular and plural implementations, regardless of whether singular or plural language is used in connection with describing certain embodiments. For example, an embodiment that describes operations of a single server device equally applies to embodiments that include multiple instances of the server device, and vice versa.

One having ordinary skill in the art will readily understand that the example embodiments as discussed above may be practiced with operations in a different order, and/or with hardware elements in configurations which are different than those which are disclosed. Therefore, although some embodiments have been described based upon these example preferred embodiments, it would be apparent to those of skill in the art that certain modifications, variations, and alternative constructions would be apparent, while remaining within the spirit and scope of example embodiments.

We claim:

1. A method, comprising:
receiving, by a system, information based on a scan of a tag associated with a plastic container,
wherein the information identifies at least:
a day that the container left a facility, or
a quantity of times that the container has been used;
determining whether the quantity of times satisfies a first threshold or whether a number of days since the day that the container left the facility satisfies a second threshold; and
based on whether the quantity of times satisfies the first threshold or the number of days satisfies the second threshold:
assessing the plastic container for use as an input material for an additive manufacturing process, or
assessing the plastic container for reuse; and
performing one or more actions related to:
recycling the plastic container, or
reusing the plastic container.

2. The method according to claim 1, wherein the tag comprises at least one of:
a barcode,
a quick response (QR) code, or
a radio frequency identifier (RFID) tag.

3. The method according to claim 1, wherein assessing the plastic container for reuse further comprises:
assessing whether an interior surface of the plastic container leaches a threshold amount of a chemical.

4. The method according to claim 1, wherein assessing the plastic container for reuse further comprises:
assessing a structural integrity of the plastic container for holding a threshold amount of material.

5. The method according to claim 4, wherein assessing the structural integrity of the plastic container further comprises:
assessing whether the plastic container can sustain a threshold amount of pressure applied to the interior or to the exterior of the plastic container.

6. The method according to claim 4, wherein assessing the structural integrity of the plastic container further comprises:
assessing whether the plastic container leaks when filled with a fluid.

7. The method according to claim 1, wherein assessing the plastic container for use as the input material further comprises:
assessing whether there is material present on an interior surface or an exterior surface of the plastic container.

8. The method according to claim 1, wherein performing the one or more actions for reuse comprises one or more of:
moving the plastic container to an area of the facility associated with reusing the plastic container,
sanitizing the plastic container, or
filling the plastic container with a material.

9. The method according to claim 1, wherein performing the one or more actions related to recycling the plastic container comprises one or more of:
moving the plastic container to an area of the facility associated with recycling the plastic container,
cleaning the plastic container,
shredding the plastic container, or
processing the shredded plastic container into the material.

10. The method according to claim 1, further comprising:
activating an alarm or outputting a message to a device indicating that the number of days satisfies the first threshold or the quantity of times satisfies the second threshold.

11. A system, comprising:
at least one processor; and
at least one memory including computer program code,
wherein the at least one memory and the computer program code are configured to, with the at least one processor, cause the apparatus at least to:
receive information based on a scan of a tag associated with a plastic container,
wherein the information identifies at least:
a day that the container left a facility, or
a quantity of times that the container has been used;
determining whether the quantity of times satisfies a first threshold or whether a number of days since the day that the container left the facility satisfies a second threshold; and
based on the quantity of times failing to satisfy the first threshold or the number of days failing to satisfy the second threshold:
assessing the plastic container for reuse; and
performing one or more actions related to reusing the plastic container based on assessing the plastic container for reuse.

12. The apparatus according to claim 11, wherein the at least one memory and the computer program code are configured to, with the at least one processor, further cause the apparatus, when assessing the plastic container for reuse, at least to:
assess whether an interior surface of the plastic container leaches a threshold amount of a chemical.

13. The apparatus according to claim 11, wherein the at least one memory and the computer program code are configured to, with the at least one processor, further cause the apparatus, when assessing the plastic container for reuse, at least to:
assess a structural integrity of the plastic container for holding a liquid.

14. The apparatus according to claim 13, wherein the at least one memory and the computer program code are configured to, with the at least one processor, further cause the apparatus, when assessing the structural integrity of the plastic container, at least to:
assess whether the plastic container can sustain a threshold amount of pressure applied to the interior or to the exterior of the plastic container.

15. The apparatus according to claim 11, wherein the at least one memory and the computer program code are configured to, with the at least one processor, further cause the apparatus, when performing the one or more actions for reuse, at least to:
move the plastic container to an area of the facility associated with reusing the plastic container,
sanitize the plastic container, or
fill the plastic container with a material.

16. A non-transitory computer readable medium comprising program instructions for causing a system to perform at least the following:
receiving information based on a scan of a tag associated with a plastic container,
wherein the information identifies at least:
a day that the container left a facility, or
a quantity of times that the container has been used;
determining whether the quantity of times satisfies a first threshold or whether a number of days since the day that the container left the facility satisfies a second threshold; and
based on whether the quantity of times satisfying the first threshold or the number of days satisfying the second threshold:
assessing the plastic container for use as an input material for an additive manufacturing process; and
performing one or more actions related to recycling the plastic container.

17. The non-transitory computer readable medium according to claim 16, wherein the program instructions further comprise program instructions for causing the apparatus, when assessing the plastic container for use as the input material, to further perform at least the following:
assess whether material is present on an interior surface or an exterior surface of the plastic container.

18. The non-transitory computer readable medium according to claim 17, wherein the program instructions further comprise program instructions for causing the apparatus, when assess whether the material is present, to further perform at least the following:
assess whether the material can be removed via a cleaning process.

19. The non-transitory computer readable medium according to claim 16, wherein the program instructions further comprise program instructions for causing the apparatus, when performing the one or more actions related to recycling the plastic container, to perform at least the following:
move the plastic container to an area of the facility associated with recycle the plastic container,
clean the plastic container,
shred the plastic container, or
process the shredded plastic container into the material.

20. The non-transitory computer readable medium according to claim 16, wherein the program instructions further comprise program instructions for causing the apparatus to perform at least the following:
activate an alarm or outputting a message to a device indicating that the number of days or the quantity of times satisfies the threshold.
